(19) United States
(12) Patent Application Publication
(10) Pub. No.: US 2021/0181142 A1
(43) Pub. Date: Jun. 17, 2021

(54) ELECTROCHEMICAL VINYL CHLORIDE SENSOR AND METHOD OF USING THE SAME

(71) Applicant: Honeywell International Inc., Charlotte, NC (US)

(72) Inventors: Lei Xiao, Shanghai (CN); Yifan Ye, Nanjing (CN); Junjie Zhai, Shanghai (CN); Gary Arthur Norval Paxton, Portsmouth (GB); Fang Wang, Shanghai (CN); Yan Zhou, Nanjing (CN)

(21) Appl. No.: 17/033,523

(22) Filed: Sep. 25, 2020

(30) Foreign Application Priority Data
Dec. 13, 2019 (CN) 201911283806.5

(51) Int. Cl. G01N 27/413; G01N 27/404

(52) U.S. Cl. CPC G01N 27/413; G01N 27/4045

(57) ABSTRACT

Various embodiments are directed to an electrochemical vinyl chloride sensor configured to detect a volume of vinyl chloride present within the volume of ambient gas. The electrochemical vinyl chloride sensor comprises a housing comprising an opening configured to receive a volume of ambient gas and an interior reservoir fluidly connected to the opening; and a plurality of electrodes fixedly disposed within the interior reservoir of the housing. The plurality of electrodes comprises a sensing electrode, a counter electrode, and a reference electrode, at least one of which comprises a catalytic material having an amorphous structure. A bias voltage of at least approximately less than 300 mV (e.g., 200 mV) applied between the sensing electrode and the reference electrode. The plurality of electrodes comprises a three-electrode stack configured such that the counter electrode is disposed between the sensing electrode and the reference electrode.

### CROSS-REFERENCE TO RELATED APPLICATIONS

This patent application claims priority to Chinese Application Ser. No. 201911283806.5, filed Dec. 13, 2019 and entitled “An Electrochemical Vinyl Chloride Sensor And Method Of Using The Same,” which is incorporated herein by reference in its entirety.

### FIELD OF THE INVENTION

Various embodiments described herein relate generally to electrochemical gas sensors. In particular, various embodiments are directed to gas sensors configured for detecting a volume of vinyl chloride within an ambient environment.

### BACKGROUND

Industrial and commercial applications may use electrochemical gas sensors to detect the presence of various gasses. In particular, an electrochemical gas sensor may be used to detect the presence of vinyl chloride. Through applied effort, ingenuity, and innovation, Applicant has solved problems relating to electrochemical gas sensors by developing solutions embodied in the present disclosure, which are described in detail below.

### BRIEF SUMMARY

Various embodiments are directed to an electrochemical vinyl chloride sensor and method of using the same. In various embodiments An electrochemical vinyl chloride sensor comprising: a housing comprising an opening configured to receive a volume of ambient gas and an interior reservoir fluidly connected to the opening; and a plurality of electrodes fixedly disposed within the interior reservoir of the housing, the plurality of electrodes comprising: a sensing electrode; a counter electrode; and a reference electrode; wherein at least one of the plurality of electrodes comprises a catalytic material having an amorphous structure; wherein a bias voltage is applied between the sensing electrode and the reference electrode; and wherein the sensor is configured to detect a volume of vinyl chloride present within the volume of ambient gas.

In various embodiments, the bias voltage may be less than approximately 300 mV. In various embodiments, the bias voltage may be approximately between 150 and 250 mV. Further, in various embodiments, the bias voltage may be approximately 200 mV.

In various embodiments, the sensing electrode may comprise a high-surface area amorphous catalytic material. Further, in various embodiments, the amorphous catalytic material of the sensing electrode may be platinum. In various embodiments, the counter electrode may comprise a high-surface area amorphous catalytic material. In various embodiments, the catalytic material of the counter electrode may be platinum.

In various embodiments, the plurality of electrodes may comprise a reverse counter electrode-reference electrode configuration; wherein the counter electrode may be disposed between the sensing electrode and the reference electrode; and wherein the counter electrode may be configured to act as a barrier for the reference electrode so as to at least partially isolate the reference electrode from a reaction initiated by the sensing electrode.

In various embodiments, an exemplary electrochemical vinyl chloride sensor may comprise one or more porous separators or other porous structures may be used to retain the electrolyte in contact with the electrodes

Various embodiments are directed to an electrochemical vinyl chloride sensor comprising: a housing; and a plurality of electrodes comprising: a sensing electrode; a counter electrode; and a reference electrode; wherein a bias voltage is applied between the sensing electrode and the reference electrode, the bias voltage being less than approximately 300 mV.

In various embodiments, the bias voltage may be approximately between 150 and 250 mV. Further, in various embodiments, the bias voltage may be approximately 200 mV. In various embodiments, at least one of the plurality of electrodes comprises a catalytic material having a high-surface area amorphous structure. In various embodiments, the high-surface area amorphous catalytic material of the sensing electrode is platinum.

Various embodiments are directed to a method of detecting vinyl chloride, the method comprising: receiving an ambient gas into a housing of a vinyl chloride sensor, wherein the ambient gas comprises a volume of vinyl chloride, and wherein the vinyl chloride sensor comprises a plurality of electrodes in contact with an electrolyte within the housing, wherein the plurality of electrodes comprises a sensing electrode, a counter electrode, and a reference electrode; applying a bias voltage between the sensing electrode and the reference electrode; contacting the ambient gas with the porous sensing electrode; allowing the ambient gas to diffuse through the sensing electrode to contact the electrolyte; generating a current between the sensing electrode and the counter electrode in response to a reaction between the ambient gas and the electrolyte at the surface area of the sensing electrode; and detecting the volume of vinyl chloride present in the ambient gas based on the current.

In various embodiments, at least one of the plurality of electrodes may comprise a catalytic material having a high-surface area amorphous structure. In various embodiments, the bias voltage applied between the sensing electrode and the reference electrode may be less than approximately 300 mV. In various embodiments, the bias voltage applied between the sensing electrode and the reference electrode may be approximately between 150 and 250 mV. In various embodiments, the plurality of electrodes comprises a reverse counter electrode-reference electrode configuration; wherein the counter electrode is disposed between the sensing electrode and the reference electrode; and wherein the counter electrode is configured to act as a barrier for the reference electrode so as to least partially isolate the reference electrode from a reaction initiated by the sensing electrode.

### BRIEF DESCRIPTION OF THE SEVERAL VIEWS OF THE DRAWINGS

Reference will now be made to the accompanying drawings, which are not necessarily drawn to scale, and wherein:

FIG. 1 schematically illustrates a cross section drawing of an electrochemical sensor according to an embodiment;

FIG. 2 illustrates an exploded view of a three-electrode stack according to an embodiment;

FIG. 3 illustrates a graph of sensor sensitivity vs. time according to one embodiment; and

FIG. 4 illustrates a graph of sensor sensitivity vs. time according to one embodiment

FIG. 5 is a flowchart illustrating an exemplary method of detecting vinyl chloride in accordance with an embodiment.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

The words “example,” or “exemplary,” when used herein, are intended to mean “serving as an example, instance, or illustration.” Any implementation described herein as an “example” or “exemplary embodiment” is not necessarily preferred or advantageous over other implementations.

Vinyl chloride is a poisonous gas that is widely produced as a byproduct of various applications in the plastics and petroleum industries. Electrochemical gas sensors may be used to detect the low concentrations of vinyl chloride, often being configured to generate a Polyvinyl Chloride (PVC) as a reaction product, which may act as a poison. In some examples, vinyl chloride may effectively act as a self-poisoning substance for electrochemical sensors, causing catastrophic failure and greatly reducing the sensitivity and/or the lifespan of electrochemical gas sensors. For example, interaction with vinyl chloride may result in the polymerization of the sensor catalyst on the surface of an electrode, thereby forming an impermeable barrier that drastically limits the electrode surface area available for further reaction. Further, vinyl chloride may poison electrochemical sensors by leaving a chlorinated species as a byproduct, which is known to kill catalysts used in electrochemical gas sensors and required in order to detect various gasses, such as, for example, vinyl chloride.

Alternatively, Ethylene Oxide sensors, when used as a means of vinyl chloride detection, have notoriously short lifespans, often failing within three to six months of first use.

Described herein is a method and apparatus for reliably detecting vinyl chloride using an electrochemical gas sensor. In some examples, the presence of a particular gas within an ambient gas received by an electrochemical gas sensor causes a reaction within the sensor that generates a current. In such cases, a bias voltage may be used to drive a reaction between the gas of interest and an electrolyte disposed within the sensor. For example, an electrochemical vinyl chloride sensor may be configured to apply a bias voltage powerful enough to drive a chemical reaction between a volume of vinyl chloride present within a volume of ambient gas and the electrolyte of the sensor.

As described by way of the examples described herein, the electrochemical vinyl chloride sensor described herein may be configured to at least partially avoid the poisoning effect of the vinyl chloride by applying an optimized bias voltage configured so as to facilitate the reaction between the volume of vinyl chloride present within the volume of ambient gas in the sensor while avoiding causing a hydrolysis reaction known to poison the of the sensor.

Further, the sensor may be configured to avoid the poisoning effect of vinyl chloride by utilizing a catalytic material comprising a high-surface area non-crystalline (e.g., amorphous) structure. As described herein, at least one of the electrodes of the sensor (e.g., the sensing electrode) may comprise a catalyst having an amorphous structure, which enables the sensor to drive the desired vinyl chloride-electrolyte reaction using a substantially reduced bias voltage. As described herein, such an applied bias voltage allows the sensor to drive the reaction between the vinyl chloride and the electrolyte, thereby facilitating the detection of said vinyl chloride within the volume of ambient gas, while avoiding all or substantially all of the poisoning of the sensor that results from a bias voltage.

As described in examples herein, by optimizing the applied bias voltage to the particular electrode and/or electrodes at which a reaction may take place, the sensor configuration described herein, wherein a reduced bias voltage is utilized in combination with a catalyst comprising an amorphous structure, enables a sensor that may exhibit an increased stability under a broad range of environments (e.g., temperature extremes, humidity extremes, and/or the like). The sensor configuration described herein enables, in some examples, a stable sensor operability that at least partially eliminates sensor inaccuracies (e.g., false alarms) and catastrophic sensor failures (e.g., due to total sensor poisoning).

Further the exemplary sensor described herein may comprise a three-electrode stack configured in a reverse counter electrode-reference electrode configuration, wherein the counter electrode is arranged between the sensing electrode and the reference electrode within the housing of the sensor. As described, the configuration of the counter electrode between the sensing electrode and the reference electrode is such that the counter electrode may act as a poisoning barrier for the reference electrode. The counter electrode may function to at least partially isolate the reference electrode from a poisoning reaction initiated by the sensing electrode, thereby mitigating a potential drift realized the reference electrode. Such an exemplary configuration may facilitate, in some examples, a more stable, longer-lasting sensor.

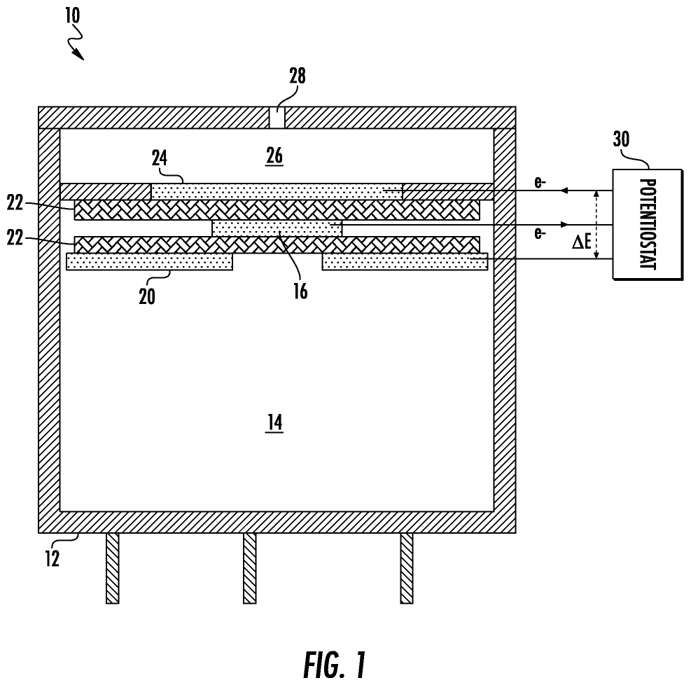

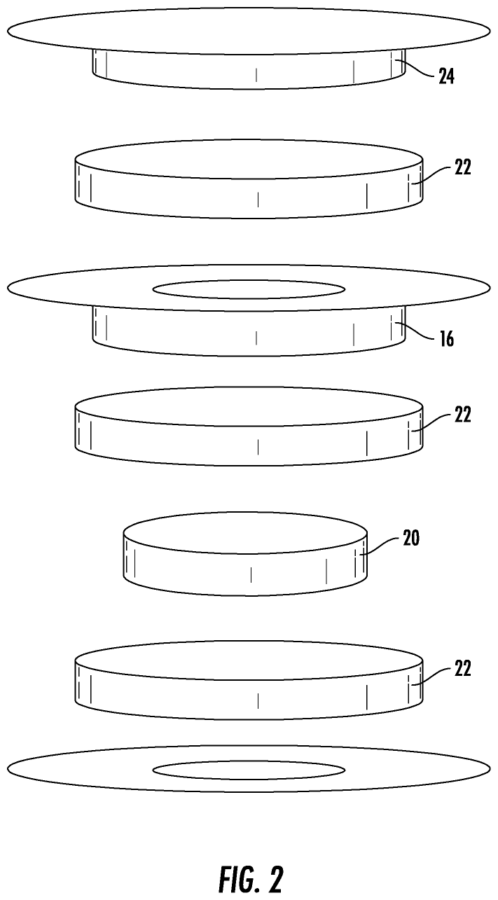

FIGS. 1 and 2 depict various embodiments of an electrochemical sensor configured to detect a volume of vinyl chloride present within the volume of ambient gas. In particular, FIG. 1 illustrates a cross section drawing of an electrochemical sensor according to an example embodiment. Further, FIG. 2 illustrates an exploded view of a three-electrode stack according to the exemplary embodiment described herein with respect to FIG. 1. The sensor 10 generally comprises a housing 12 comprising an opening 28 and an interior reservoir 14, which may be designed to hold a volume of an electrolyte solution. For example, the opening 28 of the housing 12 may be fluidly connected with the interior reservoir 14 via a gas space 26 defined by the housing 12 and positioned between the opening 12 and the reservoir 14. In various embodiments, the one or more openings 28 of the housing 12 may be configured so as to allow a volume of ambient gas present within an ambient environment in which the sensor is situated to enter the housing 12 into a gas space 26. The housing 12 may generally be formed from any material that is substantially inert to the electrolyte and gas being measured. In an embodiment, the housing 12 may be formed from a polymeric material, a metal, or a ceramic. For example, the housing may be formed from a material including, but not limited to, vinyl chloride butadiene styrene (ABS), polyphenylene oxide (PPO), polystyrene (PS), polypropylene (PP), polyethylene (PE) (e.g., high density polyethylene (HDPE)), polyphenylene ether (PPE), or any combination or blend thereof.

One or more openings 28 may be formed through the housing 12 to allow the ambient gas to enter the gas space 26 and/or allow any gases generated within the housing to escape. In an embodiment, the electrochemical sensor 10 may comprise at least one inlet opening 28 to allow the ambient gas to enter the housing 12. The opening 28 may be disposed in a cap when a cap is present and/or may be disposed in a wall of the housing 12. In some embodiments, the opening 28 may comprise a diffusion barrier to restrict the flow of gas (e.g., vinyl chloride, etc.) to the sensing electrode 24 disposed within the housing, as described herein. The diffusion barrier may be created by forming the opening 28 as a capillary and/or a film or membrane and may be used to control the mass flow rate through the one or more openings 28.

In an embodiment, the opening 28 may serve as a capillary opening to provide a rate limited exchange of the gases between the interior and exterior of the housing 12. In an embodiment, the opening 28 may have a diameter between about 200 μm and about 1.5 mm, where the opening 28 may be formed using a convention drill for larger openings and a laser drill for smaller openings. The opening 28 may have a length between about 0.5 mm and about 5 mm, depending on the thickness of the cap or housing 12. In some embodiments, two or more openings may be present for the inlet gases. When a membrane is used to control the gas flow into and/or out of the housing, the opening diameter may be larger than the sizes listed above as the film may contribute to and/or may be responsible for controlling the flow rate of the gases into and out of the housing 12.

The sensor 10 may further comprise a plurality of electrodes fixedly disposed within the interior reservoir of the housing. As shown, the plurality of electrodes may comprise a sensing electrode 24, a counter electrode 16, and a reference electrode 20, each of which may be disposed within the housing 12. In various embodiments, at least a portion of each electrode of the plurality of electrodes may be in contact with an electrolyte disposed within the interior reservoir 14 such that each of the plurality of electrodes of the sensor 10 are electronically connected to one another. For example, the electrodes may comprise a platinum material. In various embodiments, the materials used for the individual electrodes may be the same or different.

When a volume of gas (e.g., vinyl chloride) enters the sensor 10 through the opening 28 of the housing 12 and reacts with the electrolyte within the reservoir 14, an electrical current and/or potential may be developed between the electrodes. The sensor 10 may be configured to detect the presence of a particular gas and/or provide an indication of the concentration of the gas within the ambient gas based at least in part on the electrical current and/or potential developed between the electrodes.

The electrolyte may be any conventional aqueous acidic electrolyte such as sulfuric acid, phosphoric acid, or a neutral ionic solution such as a salt solution (e.g., a lithium salt such as lithium chloride, etc.), or any combination thereof. For example, the electrolyte may comprise sulfuric acid having a molar concentration between about 3 M to about 12 M. Since sulfuric acid is hygroscopic, the concentration may vary from about 10 to about 70 wt % (1 to 11.5 molar) over a relative humidity (RH) range of the environment of about 3 to about 95%. In an embodiment, the electrolyte may comprise phosphoric acid having a concentration in an aqueous solution between about 30% to about 60% H₃PO₄ by weight. As another example, the electrolyte may include a lithium chloride salt having about 30% to about 60% LiCl by weight, with the balance being an aqueous solution.

As shown in FIG. 1, in various embodiments, the sensing electrode 24 may be positioned between an opening 28 and the interior reservoir 14. The gas entering the sensor 10 may contact one side of the sensing electrode 24 and pass through sensing electrode 24 to reach the interface between the sensing electrode 24 and the electrolyte. In various embodiments, at least a portion of the volume of ambient gas that passes through the sensing electrode 24 may engage the electrolyte in contact with the sensing electrode 24, which may cause a chemical reaction between the initiate a chemical reaction between the at least a portion of the volume of ambient gas and the electrolyte. As described herein, the sensor 10 may be configured such that the chemical reaction between the gas within the sensor housing 12 and the electrolyte may generate a current indicative of the concentration of a particular gas of interest present within the volume of ambient gas. For example, the sensor 10 may be configured to detect the presence of vinyl chloride within a received volume of ambient air based at least in part on the current generated by the chemical reaction between the ambient air and the electrolyte disposed within the sensor.

As disclosed herein, the sensing electrode 24 may comprise a plurality of layers. The base or substrate layer may comprise a hydrophobic material or a hydrophobically treated material to prevent the electrolyte from passing through the sensing electrode 24. The substrate may be formed from a hydrophobic material, or the substrate may be treated with a hydrophobic material. In an embodiment, the substrate may be made hydrophobic through the impregnation of the substrate with a hydrophobic material such as a fluorinated polymer (e.g., PTFE, etc.). In some embodiments, the substrate or membrane may comprise GEFC-IES (e.g., the copolymer of perfluorosulfonic acid and PTFE, which is commercially available from Golden Energy Fuel Cell Co., Ltd.), Nafion® (a copolymer of polytetrafluoroethylene and perfluoro-3,6-dioxa-4-methyl-7-octene-sulfonic acid, which is commercially available from Dupont™), or pure or nearly pure polytetrafluoroethylene (PTFE). The impregnation process may include disposing a hydrophobic material containing solution or slurry on the substrate using a dipping, coating, or rolling process. Alternatively, a dry composition such as a powder may be applied to the substrate. In some embodiments, an optional sintering process may be used to infuse the hydrophobic material into the substrate to create the hydrophobic base layer for the sensing electrode 24, where both sides of the hydrophobic base layer are hydrophobic. The sintering process may cause the hydrophobic polymer to bond or fuse with the carbon of the substrate to securely bond the hydrophobic material to the substrate. For example, in various embodiments, the sensing electrode 24 may comprise a homogenous mix of a non-crystalline (e.g., amorphous) platinum catalyst mixed with PTFE particles consolidated onto a gas-porous PTFE substrate.

The resulting substrates may contain about 30% to about 50% by weight of the hydrophobic polymer. The amount of hydrophobic material added to the substrate may affect the electrical conductivity of the substrate, wherein the electrical conductivity tends to decrease with an increased amount of the hydrophobic material. The amount of the hydrophobic polymer used with the substrate may depend on the degree of hydrophobicity desired, the porosity to the vinyl chloride, and the resulting electrical conductivity of the sensing electrode 24.

In various embodiments, the substrate may be porous to the gas of interest, such as, for example, vinyl chloride. In various embodiments, for example, the substrate may comprise a carbon paper formed of carbon or graphite fibers. In some embodiments, the substrate may be made to be electrically conductive through the addition of a conductive material such as carbon. The use of carbon may provide a sufficient degree of electrical conductivity to allow the current generated by the reaction of the gas with the electrolyte at the surface of the sensing electrode 24 to be detected by a lead coupled to the sensing electrode 24. Other electrically conductive substrates may also be used such as carbon felts, porous carbon boards, and/or electrically conductive polymers such as polyacetylene, each of which may be made hydrophobic as described below.

Alternatively, an electrically conductive lead may be coupled to the catalytic layer to electrically couple the catalytic material to the external circuitry, as described in more detail herein. In an embodiment, the substrate may be between about 5 mils to about 20 mils thick in some embodiments. As described herein, in various embodiments a catalytic material may be formed as an electrode on one side of the sensing electrode 24 and placed in contact with the electrolyte. As described herein, the catalytic material in the sensing electrode 24 may comprise a high surface-area non-crystalline structure catalyst to provide for the detection of vinyl chloride.

In various embodiments, a counter electrode 16 may be disposed within the interior reservoir 14 of the housing 12. The counter electrode 16 may be configured such that an electrochemical reaction that occurs at the sensing electrode 24 may be balanced by a current flowing in the opposite direction at the counter electrode 16. For example, in an exemplary embodiment wherein the plurality of electrode comprises a three-electrode stack, such a configuration may enable the potential difference between the sensing electrode 24 and the reference electrode 20 to be measured without passing any current through the reference electrode 20. As described herein, the counter electrode 16 may comprise a substrate or membrane such as a PTFE membrane, a GEFC-IES membrane, a Nafion® membrane, and/or the like having a catalytic material disposed thereon.

In various embodiments, a reference electrode 20 may be disposed within the interior reservoir 14 of the housing 12. The reference electrode 20 may establish an electrical potential so as to provide a reference against which the potential of the sensing electrode 24 may be measured. For example, the potential difference between the potential difference between the sensing electrode 24 and the reference electrode 20 may be measured to repeatably analyze the potential of the sensing electrode 24. As described herein, the reference electrode 20 may comprise a substrate or membrane such as a PTFE membrane, a GEFC-IES membrane, a Nafion® membrane, and/or the like having a catalytic material disposed thereon.

In some embodiments, one or more porous separators 22 or other porous structures may be used to retain the electrolyte in contact with the electrodes. The separators 22 may comprise a porous member that acts as a wick for the retention and transport of the electrolyte between the reservoir and the electrodes while being electrically insulating to prevent shorting due to direct contact between two of the plurality of electrodes. In various embodiments, one or more of the separators 22 may comprise a nonwoven porous material (e.g., a porous felt member), a woven porous material, a porous polymer (e.g., an open cell foam, a solid porous plastic, etc.), or the like, and is generally chemically inert with respect to the electrolyte and the materials forming the electrodes. In an embodiment, the separator 22 may be formed from various materials that are substantially chemically inert to the electrolyte including, but not limited to, glass (e.g., a glass mat), polymer (plastic discs), ceramics, or the like. One or more of the porous separator 22 may extend into the reservoir to provide the electrolyte a path to the electrodes. In an embodiment, a separator 22 may be disposed between the counter electrode 16 and the reference electrode 20, and a separator 22 may be disposed between the reference electrode 20 and the sensing electrode 24. Alternatively, in various embodiments, as described herein, a separator 22 may be disposed between the reference electrode 20 and the counter electrode 16, and a separator 22 may be disposed between the counter electrode 16 and the sensing electrode 24.

In various embodiments, one or more leads or electrical contacts may be electrically coupled to the sensing electrode 24, the reference electrode 20, and/or the counter electrode 16 in order to detect the current and/or potential difference across the electrodes in response to the presence of the vinyl chloride. In various embodiments wherein a substrate of the sensing electrode 24 comprises an electrically conductive material, a lead contacting the sensing electrode 24 may contact either side of the sensing electrode 24. In order to avoid the corrosive effects of an electrolyte, the lead contacting the sensing electrode 24 may contact the side of the sensing electrode 24 that is not in contact with the electrolyte. In various embodiments, leads may be similarly electrically coupled to the counter electrode 16 and/or the reference electrode 20. In various embodiments, electrical leads may be electrically coupled to external connection pins to provide an electrical connection to external processing circuitry. For example, the external circuitry may comprise a potentiostat 30 The potentiostat 30 may detect the current and/or potential difference between the electrodes. Based at least in part on the detected current and/or potential difference between the electrodes, the potentiostat 30 may be configured to detect whether or not a volume of vinyl chloride is present within a volume of ambient gas received by the sensor 10. In various embodiments, the potentiostat 30 may be configured to convert the current into a corresponding value indicating the concentration of vinyl chloride within the volume of ambient gas.

The exemplary embodiment illustrated in FIGS. 1 and 2 comprises a three-electrode stack configuration wherein the reference electrode 20 is disposed within the interior reservoir 14 in between a sensing electrode 24 and a counter electrode 16. In such a configuration, the exemplary sensor 10 comprises a reverse counter electrode-reference electrode configuration. Alternatively, an exemplary electrochemical vinyl chloride sensor may comprise a three-electrode stack configuration wherein the reference electrode 20 is disposed between a sensing electrode 24 and a counter electrode 16. Further, in various embodiments, an exemplary electrochemical vinyl chloride sensor may comprise an electrode stack configuration wherein the reference electrode 20 is coplanar with the counter electrode 16 in at least substantially the same horizontal plane. In such a configuration, the reference electrode 20 and the counter electrode 16 may be at least substantially parallel with the sensing electrode 24.

In various embodiments, a reverse counter electrode-reference electrode configuration, wherein the counter electrode 16 is positioned between the sensing electrode 24 and the reference electrode 20, may enable the counter electrode 16 to act as a poisoning barrier for the reference electrode 20. The counter electrode 16 may function to at least partially isolate the reference electrode 20 from a poisoning reaction initiated by the sensing electrode 24, thereby mitigating a potential drift realized the reference electrode 20. Such an exemplary configuration may facilitate a more stable, longer-lasting sensor 10.

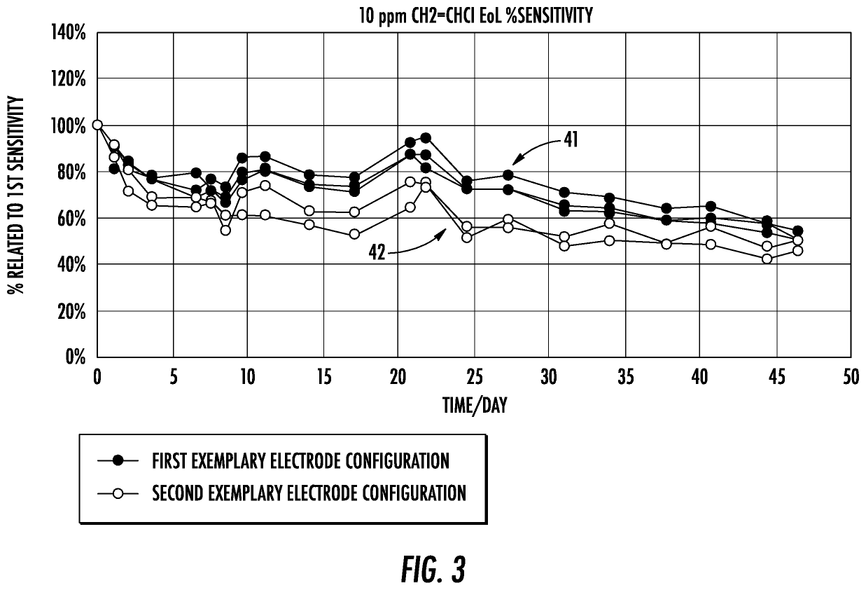

As a non-limiting, illustrative example, FIG. 3 shows a graphical representation of the percentage difference in sensitivity realized by two exemplary sensor embodiments over the span of 47 days. An experiment was conducted wherein various sensors comprising a first exemplary electrode configuration and a second exemplary electrode configuration, configured according to various embodiments described herein, were subjected to an ambient gas comprising an equal amount 10 ppm of vinyl chloride over a 47-day time period. After each day, the sensitivity of each sensor was measured relative to the 100% sensitivity of the sensor realized at the start of the experiment and the data was plotted in the line graph shown in FIG. 3. Sensors comprising the first exemplary sensor configuration comprised a reverse counter electrode-reference electrode configuration, as described herein, wherein a counter electrode is disposed between a sensing electrode and a reference electrode. Sensors comprising the second exemplary sensor configuration comprised an electrode configuration in which the reference electrode is disposed between a sensing electrode and a counter electrode. The data corresponding to the first exemplary sensor embodiment is shown as first data set 41, while the data corresponding to the second exemplary sensor embodiment is shown as second data set 42.

The exemplary experiment included the execution of various distinct trials, resulting in the first data set 41 comprising three distinct sets of test results and the second data set 42 comprising two distinct sets of test results. As illustrated in FIG. 3, the first data set 41 comprises sensitivity values that consistently measured as being greater than that of the second data set 42. Such an experimental result may indicate that the first exemplary sensor embodiment (e.g., the sensor comprising the reverse counter electrode-reference electrode configuration) was more resistant to the poisoning effect of the volume vinyl chloride engaged therewith than was the second exemplary configuration (e.g., the sensor comprising the reverse counter electrode-reference electrode configuration) throughout each of the experiments three trials. As shown, the first data set 41 indicates the sensitivity of the first exemplary sensor embodiment remained at 53% of its original value after 17050 ppm*hours. For example, such a value indicates may be used empirically to shown that given a vinyl chloride concentration of 2 ppm, the first exemplary gas sensor may be expected to retain 53% sensitivity after approximately 355 days.

In various embodiments, at least one of the electrodes of the plurality of electrodes may comprise a catalytic material (e.g., a catalyst). As described herein, the catalytic material of at least one of the plurality of electrodes may comprise a high surface-area non-crystalline (e.g., amorphous) structure, as described herein, to provide for the detection of vinyl chloride. For example, in various embodiments, the high-surface area amorphous catalyst material of the at least one of the plurality of electrodes may comprise an amorphous platinum. The catalyst used may be a pure metal powder, a metal powder combined with carbon, or a metal powder supported on an electrically conductive medium such as carbon, or a combination of two or more metal powders either as a blend or as an alloy. In various embodiments, a catalyst comprising an amorphous structure may be used to at least partially mitigate the extent to which the catalyst poisons the sensor 10 upon reacting with a vinyl chloride gas, as described herein. Modifying the morphology of the catalyst such that the catalyst comprises a high-surface area amorphous structure may mitigate and/or eliminate the polymerization process that occurs on the catalyst surface, thereby avoiding, at least in part, the generation of a resultant impermeable barrier thereon that functions to limit the catalyst surface area available for further reaction. Additionally and/or alternatively, utilizing catalyst comprising a high-surface area amorphous structure may at least partially limit the extent to which chlorinated species are left as reaction byproducts. In various embodiments, using a catalyst comprising a non-crystalline (e.g., amorphous) structure as described herein may only allow for a monochloride reaction while avoiding hydrolysis, thereby avoiding the crystallization of polyvinyl chloride. As such, an exemplary sensor 10 wherein at least one of the plurality of electrodes comprises a high-surface area, amorphous-structure catalyst reduces the poisoning effect that a volume of vinyl chloride gas may have on an electrochemical sensor, thereby facilitating a more stable, longer-lasting sensor 10.

As described herein, in various embodiments, the amorphous catalyst may comprise a high-surface area amorphous platinum defined at least in part by a morphology configured to mitigate poisoning effect of a detected volume of vinyl chloride. For example, in various embodiments, the surface area of an exemplary amorphous platinum catalyst may be at least approximately between 19 m2/g-25 m2/g. Further, in various embodiments, an exemplary amorphous platinum catalyst may comprise a particle size of at least approximately between D50 0.26 mm-0.33 mm. An amorphous-structured platinum catalyst utilized by the sensor may comprise, for example, a tapped density of 0.65 to 0.85 g/mL. Further, in various embodiments, an exemplary amorphous platinum catalyst may comprise an assay of at least substantially greater than 97% platinum by weight. In various embodiments, for example, one or more electrodes of the exemplary sensor 10 may comprise a ratio of at least approximately between 5%-20% PFTE to amorphous platinum catalyst.

In various embodiments, the catalytic layer of the sensing electrode 24 may be formed by mixing the desired catalytic material (e.g., a catalyst) with a binder and depositing the mixture on the substrate material, as described herein. For example, the binder may comprise a solution of perfluorinated ion electrolyte solution (e.g., GEFC-IES, Nafion®, etc.), a hydrophobic material such as PTFE, mixtures thereof, or the like. When used as a binder, the GEFC-IES Nafion®, and/or PTFE may affect the gas diffusion parameters while supporting the electrocatalyst and maximizing the interfaces between catalyst, gas and electrolyte at which the electrochemical processes occur. Glycol or other similar chemicals may be used as a diluent to form a catalyst slurry, recipe or catalyst system, which may be printed on a substrate by a printer.

In various embodiments, the catalytic layer of the sensing electrode 24 may be deposited onto a substrate thereof by for example screen printing, filtering in selected areas from a suspension placed onto the substrate, by spray coating, or any other method suitable for producing a patterned deposition of solid material. Deposition might be of a single material or of more than one material sequentially in layers, so as for example to vary the properties of the electrode material through its thickness or to add a second layer of increased electrical conductivity above or below the layer which is the main site of gas reaction. Once deposited, the printed element may be sintered at an elevated temperature to form the electrode.

In various embodiments, the counter electrode 16 and/or the reference electrode 20 may similarly comprise a catalytic layer comprising a catalytic material (e.g., a catalyst). In various embodiments, any of the one or more methods used to form the sensing electrode or the counter electrode may also be used to prepare the counter electrode 16 and/or the reference electrode 20. For example, in an exemplary embodiment, the catalytic material may be mixed with a hydrophobic material (e.g., PTFE, etc.) and disposed on the PTFE membrane of one or both of the counter electrode 16 and the reference electrode 20. In various embodiments, a catalytic material may be mixed and disposed on a membrane of one or both of the counter electrode 16 and the reference electrode 20 using any suitable process such as rolling, coating, screen printing, and/or the like to apply the catalytic material on the membrane, as described in more detail herein. In such a circumstance, the catalyst layer may be bonded to the membrane through a sintering process, as described herein.

In various embodiments, the catalyst loading for the counter electrode 16 and/or the reference electrode 20 may be within any of the ranges described herein for the sensing electrode 24. In various embodiments, the catalyst loading for the counter electrode 16 may be at least substantially the same as the catalyst loading for the sensing electrode 24. Alternatively, in various embodiments, the catalyst loading for the counter electrode 16 may be either greater than or less than that of the sensing electrode 24. Further, in various embodiments, the catalyst loading for the reference electrode 20 may be at least substantially the same as the catalyst loading for the sensing electrode 24. Alternatively, in various embodiments, the catalyst loading for the reference electrode 20 may be either greater than or less than that of the sensing electrode 24.

In various embodiments, the electrochemical vinyl chloride sensor 10 described herein may be configured to at least partially avoid a poisoning effect of a volume of vinyl chloride by applying an optimized bias voltage configured so as to facilitate the reaction between the volume of vinyl chloride present within the volume of ambient gas in the sensor while avoiding causing a hydrolysis reaction known to poison the of the sensor. In various embodiments, the sensor 10 may be configured such that a voltage potential difference (e.g., a bias voltage) may be applied between at least two of the plurality of electrodes. For example, the sensor 10 may be configured to apply a bias voltage between the reference electrode 20 and the sensing electrode 24. In such a configuration, the sensor 10 may exhibit a voltage potential difference between the reference electrode 20 and the sensing electrode 24.

As described herein, the sensor 10 may be configured to apply a bias voltage to one or more electrodes of the plurality of electrodes of the sensor 10 in order to drive a reaction between a gas of interest and an electrolyte. An applied bias voltage may be configured so as to ensure that the sensor 10 may operably produce a base current reading, thereby facilitating the detection of the gas of interest upon a reaction between the gas of interest and the electrolyte of the sensor 10. For example, in various embodiments, an applied bias voltage may be insufficiently small such that it is too weak to drive a reaction (e.g., the reaction rate of the gas of interest, such as, for example, vinyl chloride, is insufficiently slow). Accordingly, as described herein, the applied bias voltage of the sensor 10 must have a magnitude that is above a minimum threshold voltage necessary to initialize a chemical reaction wherein the reaction rate between a volume of vinyl chloride and the electrolyte is such that a current is generated within the sensor 10. For example, in various embodiments, the minimum threshold bias voltage that will sufficiently drive a reaction between the gas of interest, such as, for example, vinyl chloride and an electrolyte may be at least approximately 300 mV.

In various embodiments, at least one of the electrodes of the sensor 10 (e.g., the sensing electrode 24) may comprise a catalyst having a high-surface area non-crystalline (e.g., amorphous) structure, which may enable the sensor 10 to utilize a bias voltage of at least substantially between 150 mV and 250 mV. The applied bias voltage may be optimized by reducing the voltage so as to avoid the poisoning of the sensor 10 that may result from applying a bias voltage having a magnitude that is great enough to cause a hydrolysis reaction between the vinyl chloride and the electrolyte of the sensor (e.g., 300 mV). Such an optimization may facilitate the reaction between the volume of vinyl chloride present within the volume of ambient gas in the sensor 10 while avoiding the poisoning of the sensor 10 due to hydrolysis. In various embodiments, the applied bias voltage of at least substantially between 150 mV and 250 mV may be further optimized based on the specific electrode weight. For example, the sensor 10 may be configured to capture the desired vinyl chloride-electrolyte reaction using a nominal bias voltage of approximately 200 mV. As described herein, such an applied bias voltage allows the sensor 10 to drive the reaction between the vinyl chloride and the electrolyte, thereby facilitating the detection of said vinyl chloride within the volume of ambient gas, while avoiding the poisoning of the electrochemical sensor 10 that may result from a bias voltage of, for example, 300 mV. In various embodiments, the sensor 10 may be configured so as to enable the operability of a bias voltage of at least substantially lower than 300 mV either with or without an electrode comprising a catalyst having an amorphous structure.

In various embodiments, one or more bias voltage values may be sufficient to facilitate the reaction between the volume of vinyl chloride present within the volume of ambient gas in the sensor 10 while avoiding the poisoning of the sensor 10. In such a configuration, an operable bias voltage may be within a desired potential window, the potential window defining a range of voltages that facilitate a reaction between a volume of vinyl chloride present within a sensor 10 while avoiding the poisoning of the sensor 10 due to hydrolysis, for example. In various embodiments, the voltage potential applied between the sensing electrode and the reference electrode may less than approximately 300 mV. For example, the voltage potential applied between the counter electrode and the sensing electrode may be at least approximately between 150 mV and 250 mV (e.g., 200 mV).

As described herein, the applied bias voltage may be optimized based at least in part on the weight of one or more of the electrodes of the sensor 10. By optimizing the applied bias voltage to the particular electrode and/or electrodes at which a reaction may take place, the sensor configuration described herein, wherein a reduced bias voltage is utilized in combination with a catalyst comprising an amorphous structure, enables a sensor 10 that may exhibit an increased stability under a broad range of environments (e.g., temperature extremes, humidity extremes, and/or the like). The sensor configuration described herein enables a stable sensor operability the at least partially eliminates sensor inaccuracies (e.g., false alarms) and catastrophic sensor failures (e.g., due to total sensor poisoning). Optimizing the applied bias voltage, for example, between 150 mV and 300 mV based on the specific electrode weight, ensures both an operable base current reading and a desired sensor lifespan.

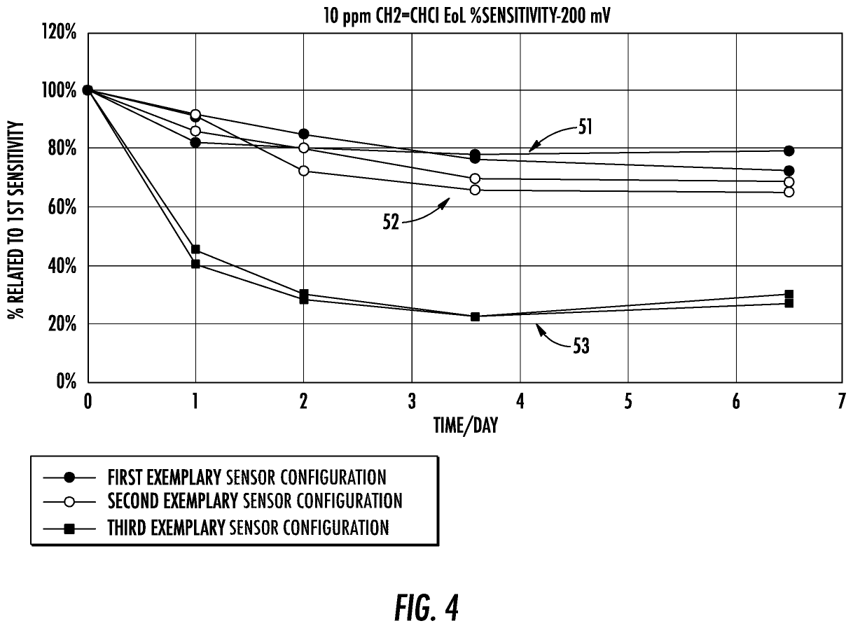

As a non-limiting, illustrative example, FIG. 4 shows a graphical representation of the percentage difference in sensitivity realized by three exemplary sensor embodiments over the span of approximately 6.5 days. An experiment was conducted wherein sensors comprising a first exemplary sensor configuration, a second exemplary sensor configuration, and a third exemplary sensor configuration were each subjected to an ambient gas comprising an equal amount 10 ppm of vinyl chloride over a 6.5-day time period. A bias voltage of 200 mV was applied to each of the sensors throughout the experiment. After each day, the sensitivity of each sensor was measured relative to the 100% sensitivity of the sensor realized at the start of the experiment and the data was plotted in the line graph shown in FIG. 4.

The data corresponding to the first exemplary sensor configuration, the second exemplary sensor configuration, and the third exemplary sensor configuration are shown as first data set 51, second data set 52, and third data set 53, respectively. The exemplary experiment included the execution of various distinct trials, resulting in the first data set 51 comprising three distinct sets of test results and both the second data set 52 and the third data set 53 comprising two distinct sets of test results.

The first exemplary sensor configuration and the second exemplary sensor were configured according to various embodiments described herein, each comprising a catalyst having an amorphous structure. The third exemplary sensor embodied an ethylene oxide gas sensor comprising a catalyst having a crystalline structure. In particular, the catalysts utilized in the first and second exemplary sensor configurations comprised approximately 100 mg amorphous platinum, while the catalyst utilized in the third exemplary sensor configuration comprised approximately 120 mg crystalline platinum. Further, the first exemplary sensor configuration was configured so as to comprise a reverse counter electrode-reference electrode configuration, as described herein. The second exemplary sensor was configured so as to comprise an electrode configuration in which the reference electrode is disposed between a sensing electrode and a counter electrode.

As illustrated in FIG. 4, the third data set 53 shows that sensors comprising the third exemplary sensor configuration, an ethylene oxide sensor with 120 mg of a crystalline platinum catalyst, significantly decreased to approximately between 40%-50% within the first day and continued to decrease to approximately 20% sensitivity after 3.5 days of testing. Conversely, the first and second data sets 51, 52, both of which are indicative of the results of a sensor configured to utilize a catalyst having an amorphous structure, illustrate a more stable sensor performance. The second data set 52 shows that after 6.5 days of testing, sensors comprising the second exemplary sensor configuration exhibited sensitivity values of between 65%-70%. Similarly, the first data set 51 shows that after the same amount of time, sensors comprising the first exemplary sensor configuration exhibited sensitivity values of between 70%-80%. FIG. 4 illustrates that with a 200 mV bias voltage, those sensors comprising a catalyst having an amorphous structure were able to more effectively resist the poisoning effect of the volume vinyl chloride engaged therewith than were those sensors comprising a crystalline catalyst, despite using a lesser amount of catalyst (e.g., 100 mg of amorphous catalyst compared to 120 mg of crystalline catalyst). As indicated by the discrepancies between the third data set 53 and the first and second data sets 51, 52, the poisoning resistance facilitated by the use of the amorphous catalyst in the electrochemical sensor results at the 200 mV bias voltage enables increased sensor stability and an optimized sensor performance over an extended period of time.

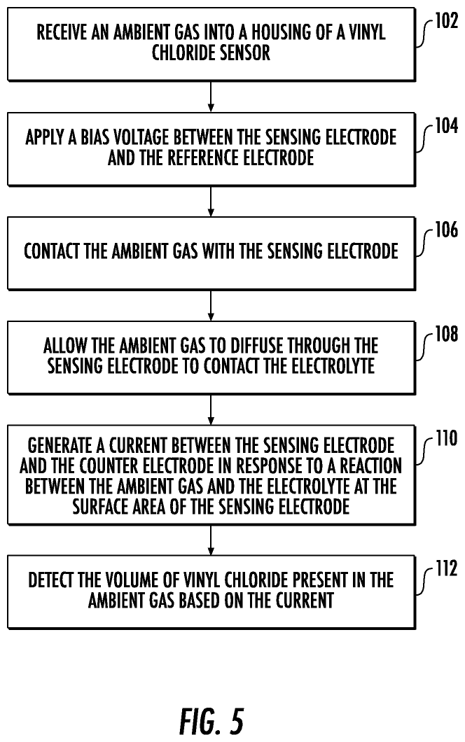

Various embodiments, as described herein, are directed to a method of detecting vinyl chloride. For example, as shown at Blocks 102-112 of FIG. 5, an electrochemical gas sensor may be provided to detect a volume of vinyl chloride within a volume of ambient gas received by the sensor. A volume of ambient gas may be received by an electrochemical sensor, as described herein. For example, the volume of ambient gas may flow into the sensor through an opening, which may serve as an intake port for the sensor. In various embodiments, the volume of ambient gas may comprise a volume of vinyl chloride. The sensor may comprise a plurality of electrodes in contact with an electrolyte disposed within a sensor housing, the plurality of electrodes comprising a sensing electrode and a counter electrode. In various embodiments, at least a portion of the volume of ambient gas may contact porous sensing electrode. For example, the at least a portion of the ambient gas may pass through a porous substrate layer of the exemplary sensing electrode to reach a surface of the sensing electrode treated with a catalyst layer. In various embodiments, the catalytic material of the catalyst layer may comprise an amorphous structure having a high-surface area. As described herein, the catalytic material of the sensing electrode may be in contact with an electrolyte disposed within a sensor housing. In various embodiments, the plurality of electrodes may further comprise a reference electrode. For example, the counter electrode may be positioned within the housing of the sensor in between the sensing electrode and the reference electrode.

In various embodiments, a voltage (e.g., a bias voltage) may be applied between at least two of the plurality of electrodes. For example, a bias voltage may be applied between the sensing electrode and the reference electrode. In such a configuration, applying a bias voltage may result a potential difference between the sensing electrode and the reference electrode, which may, at least in part, be measured relative to a voltage applied to an exemplary reference electrode. For example, in various embodiments, the voltage potential applied between the sensing electrode and the reference electrode may less than approximately 300 mV. For example, the voltage potential applied between the sensing electrode and the reference electrode may at least approximately between 150 mV and 250 mV (e.g., 200 mV).

The volume of vinyl chloride present within the volume of ambient gas may spur a chemical reaction at the portion of the sensing electrode in contact with the electrolyte. In various embodiments, a current may be generated between the sensing electrode and the counter electrode in response to the reaction between the ambient gas and the electrolyte at the surface area of the sensing electrode. As described herein, based at least in part on the presence of the volume of vinyl chloride, such a chemical reaction may produce an electrolytic current that runs between the sensing electrode and the counter electrode. In various embodiments, the current generated may correspond to the concentration of the vinyl chloride within the ambient gas. In various embodiments, the presence of vinyl chloride within the volume of ambient gas received by the exemplary sensor may be determined based at least in part on an analysis of the generated circuitry by, for example, external detection circuitry such as a potentiostat.

In some embodiments, the volume of ambient gas received by the sensor may further comprise an interferent gas, such as, for example, carbon monoxide, which may come into contact with the catalytic later of the sensing electrode. The carbon monoxide, for example, may react with the electrolyte in contact with the surface of the sensing electrode at either the same rate or a different rate than the reaction rate of the vinyl chloride, as described herein. In various embodiments, a volume of carbon monoxide may experience a diffusional resistance within the sensor. In various embodiments, wherein one or more of the plurality of electrodes comprises a catalytic later, the catalytic later may cause the reaction rate of the vinyl chloride, for example, at the sensing electrode, to be faster than the reaction of an interferent gas, such as carbon monoxide. A catalytic material having a higher reactivity for vinyl chloride than for carbon monoxide may be added to at least one of the plurality of electrodes, which may effectively increase the relative contribution to the overall current from the reaction of the vinyl chloride compared to that from the reaction of carbon monoxide. As described, the cross-sensitivity of the sensor to carbon monoxide may be reduced to an acceptable level.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An electrochemical vinyl chloride sensor comprising:
a housing comprising an opening configured to receive a volume of ambient gas and an interior reservoir fluidly connected to the opening; and
a plurality of electrodes fixedly disposed within the interior reservoir of the housing, the plurality of electrodes comprising:
a sensing electrode;
a counter electrode; and
a reference electrode;
wherein at least one of the plurality of electrodes comprises a catalytic material having an amorphous structure;
wherein a bias voltage is applied between the sensing electrode and the reference electrode; and
wherein the sensor is configured to detect a volume of vinyl chloride present within the volume of ambient gas.

2. The sensor of claim 1, wherein the bias voltage is less than approximately 300 mV.

3. The sensor of claim 2, wherein the bias voltage is approximately between 150 and 250 mV.

4. The sensor of claim 3, wherein the bias voltage is approximately 200 mV.

5. The sensor of claim 1, wherein the sensing electrode comprises a high-surface area amorphous catalytic material.

6. The sensor of claim 5, wherein the amorphous catalytic material of the sensing electrode is platinum.

7. The sensor of claim 1, wherein the counter electrode comprises a high-surface area amorphous catalytic material.

8. The sensor of claim 7, wherein the catalytic material of the counter electrode is platinum.

9. The sensor of claim 1, wherein the plurality of electrodes comprises a reverse counter electrode-reference electrode configuration; wherein the counter electrode is disposed between the sensing electrode and the reference electrode; and wherein the counter electrode is configured to act as a barrier for the reference electrode so as to at least partially isolate the reference electrode from a reaction initiated by the sensing electrode.

10. The sensor of claim 1, further comprising one or more porous separators or other porous structures may be used to retain the electrolyte in contact with the electrodes

11. An electrochemical vinyl chloride sensor comprising:
a housing; and
a plurality of electrodes comprising:
a sensing electrode;
a counter electrode; and
a reference electrode;
wherein a bias voltage is applied between the sensing electrode and the reference electrode, the bias voltage being less than approximately 300 mV.

12. The sensor of claim 11, wherein the bias voltage is approximately between 150 and 250 mV.

13. The sensor of claim 12, wherein the bias voltage is approximately 200 mV.

14. The sensor of claim 11, wherein at least one of the plurality of electrodes comprises a catalytic material having a high-surface area amorphous structure.

15. The sensor of claim 14, wherein the high-surface area amorphous catalytic material of the sensing electrode is platinum.

16. A method of detecting vinyl chloride, the method comprising:
receiving an ambient gas into a housing of a vinyl chloride sensor, wherein the ambient gas comprises a volume of vinyl chloride, and wherein the vinyl chloride sensor comprises a plurality of electrodes in contact with an electrolyte within the housing, wherein the plurality of electrodes comprises a sensing electrode, a counter electrode, and a reference electrode;
applying a bias voltage between the sensing electrode and the reference electrode;
contacting the ambient gas with the sensing electrode;
allowing the ambient gas to diffuse through the sensing electrode to contact the electrolyte;
generating a current between the sensing electrode and the counter electrode in response to a reaction between the ambient gas and the electrolyte at the surface area of the sensing electrode; and
detecting the volume of vinyl chloride present in the ambient gas based on the current.

17. The method of claim 16, wherein at least one of the plurality of electrodes comprises a catalytic material having a high-surface area amorphous structure.

18. The method of claim 16, wherein the bias voltage applied between the sensing electrode and the reference electrode is less than approximately 300 mV.

19. The method of claim 18, wherein the bias voltage applied between the sensing electrode and the reference electrode is approximately between 150 and 250 mV.

20. The method of claim 16, wherein the plurality of electrodes comprises a reverse counter electrode-reference electrode configuration; wherein the counter electrode is disposed between the sensing electrode and the reference electrode; and wherein the counter electrode is configured to act as a barrier for the reference electrode so as to least partially isolate the reference electrode from a reaction initiated by the sensing electrode.
